(19) United States
(12) Patent Application Publication
(10) Pub. No.: US 2026/0330554 A1
(43) Pub. Date: Oct. 22, 2026

(54) PANTRY MANAGEMENT SYSTEM WITH CARBON FOOTPRINT TRACKING

(71) Applicant: Swapna Chappidi, Plainsboro, NJ (US)

(72) Inventor: Swapna Chappidi, Plainsboro, NJ (US)

(21) Appl. No.: 19/185,712

(22) Filed: Apr. 22, 2025

(51) Int. Cl. G06Q 40/06; G06Q 10/087; G06Q 30/018

(52) U.S. Cl. CPC G06Q 40/06; G06Q 10/087; G06Q 30/018

(57) ABSTRACT

This application provides a comprehensive platform that integrates financial and environmental protection benefits by monitoring the carbon footprint, addressing food waste and promoting sustainability. Designed for individuals committed to eco-conscious living and efficient household management, the app optimizes food consumption, reduces waste, and enhances cost savings. By bridging the gap between consumers, retailers, and environmental organizations, it effectively mitigates financial, environmental, and operational inefficiencies. The platform leverages advanced tracking and predictive analytics to recommend smarter purchasing decisions, monitor food expiration, and connect users with businesses and organizations focused on sustainability. Consumers benefit from reduced grocery costs and waste, while retailers and environmental groups gain insights to optimize supply chains and sustainability efforts. By catering to all stakeholders, this app fosters a win-win ecosystem that aligns economic incentives with environmental responsibility. It transforms food management into an intelligent, data-driven process, contributing to a more sustainable, cost-effective, and waste-conscious society.

### FIELD OF THE INVENTION

The present disclosure relates to household inventory management systems. More specifically, it pertains to digital applications for tracking and managing pantry items with integrated sustainability metrics and financial analysis capabilities.

### BACKGROUND

Food waste is a significant global issue, with billions of pounds of food wasted annually. In the United States alone, food waste accounts for 30-40% of the food supply, amounting to approximately 133 billion pounds and $161 billion worth of food each year. This waste significantly contributes to environmental challenges, generating 8-10% of global greenhouse gas emissions, including methane from landfills. Addressing food waste is critical for enhancing sustainability, reducing greenhouse gas emissions, and easing the strain on the planet's resources.

Existing pantry management applications typically focus on basic inventory tracking and may provide simple expiration date reminders. However, these applications often lack comprehensive features that address the broader issues of sustainability, financial impact, and environmental consciousness. There is a need for an integrated solution that not only manages household inventories but also promotes sustainable consumption habits and provides actionable insights into the environmental and financial impacts of food waste.

### BRIEF OVERVIEW

Embodiments of the present disclosure relate to systems, methods, and devices for pantry management with integrated carbon footprint tracking and financial analysis. The disclosed invention, referred to as EcoPantryPal, provides a comprehensive solution for managing household inventories while promoting sustainability and environmental consciousness. In one aspect, a method for pantry management includes receiving input data related to household items, storing the input data in a database, tracking usage and expiration of the items, calculating financial and environmental impacts of item usage and waste, and generating reports and recommendations based on the tracked data.

In another aspect, a system for pantry management includes a user interface for inputting and displaying item data, a database for storing item information, a processor for analyzing usage patterns and calculating impacts, and a notification module for alerting users to expiring items and providing sustainability recommendations. In yet another aspect, a non-transitory computer-readable medium stores instructions that, when executed by a processor, cause the processor to perform operations including receiving item data, updating an inventory database, fetching the carbon footprint by integrating with other companies who provide the carbon foot print and financial impacts of item usage and waste, and generating personalized recommendations for reducing waste and environmental impact.

These and other features, aspects, and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

It should be noted that the above description is merely illustrative and non-limiting. The present disclosure may include additional features, aspects, and advantages not explicitly described herein. Furthermore, the features, aspects, and advantages described may be combined in various ways to create additional embodiments within the scope of the present disclosure.

### BRIEF DESCRIPTION OF THE DRAWINGS

The accompanying drawings, which are incorporated in and constitute a part of this specification, illustrate embodiments of the disclosure and, together with the description, serve to explain the principles of the disclosure.

FIG. 1 is a flowchart illustrating user interactions within a pantry management application with carbon footprint tracking, in accordance with embodiments of the present disclosure.

FIG. 2 is a top down vertical interaction diagram showing the flow of information between a user, the pantry management application, and a retailer, in accordance with embodiments of the present disclosure.

FIG. 3 is a schematic illustration of a mobile dashboard interface displaying current monthly statistics for a pantry management system, in accordance with embodiments of the present disclosure.

FIG. 4 is a schematic illustration of a smartphone screen displaying a pantry dashboard with item details, in accordance with embodiments of the present disclosure.

FIG. 5 is a schematic illustration of a mobile device screen showing categories of items in a pantry management system, in accordance with embodiments of the present disclosure.

FIG. 6 is a schematic illustration of a mobile app interface displaying data on expired items and associated waste trends, in accordance with embodiments of the present disclosure.

FIG. 7 is a schematic illustration of a smartphone screen showing a scanning interface for adding items to a pantry management system, in accordance with embodiments of the present disclosure.

FIG. 8 is a schematic illustration of a smartphone screen displaying a barcode scanner in use, in accordance with embodiments of the present disclosure.

FIG. 9 is a schematic illustration of a mobile app interface showing scan results for an item, in accordance with embodiments of the present disclosure.

FIG. 10 is a schematic illustration of a mobile app interface for reviewing scanned items from a receipt, in accordance with embodiments of the present disclosure.

It should be noted that the figures are not necessarily drawn to scale, and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

Reference will now be made in detail to embodiments of the present disclosure, examples of which are illustrated in the accompanying drawings. Wherever possible, the same reference numbers will be used throughout the drawings to refer to the same or like parts. Embodiments of the present disclosure provide systems, methods, and devices for comprehensive pantry management with integrated carbon footprint tracking and financial analysis. The disclosed invention, referred to as EcoPantryPal, addresses the limitations of existing pantry management solutions by incorporating sustainability features, automated data entry, and actionable insights to promote eco-conscious consumption habits.

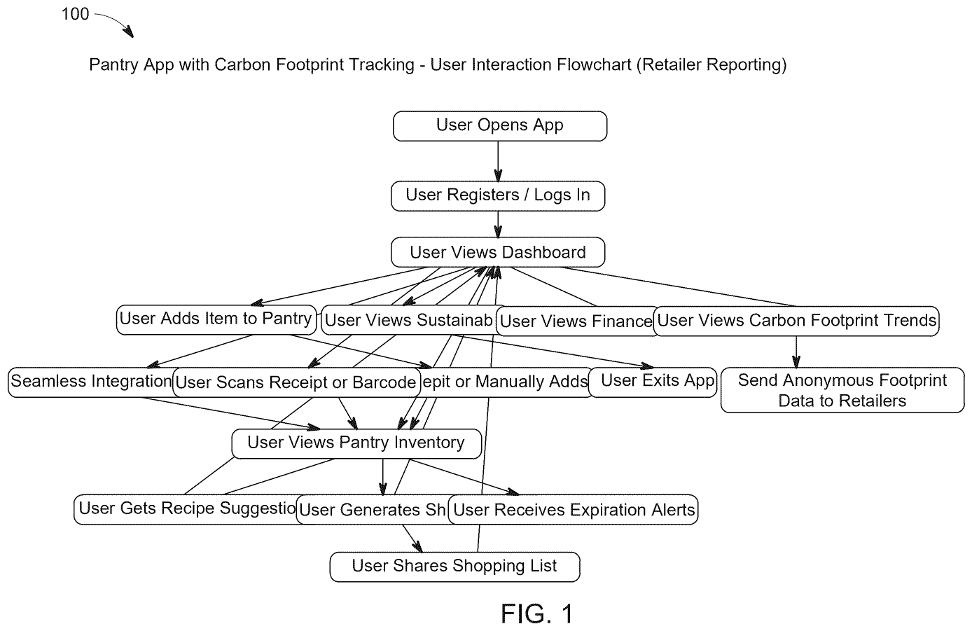

FIG. 1 illustrates a flowchart of user interactions within the EcoPantryPal application. The process begins when a user opens the app and logs in. The user is then presented with a dashboard displaying various options and information. From the dashboard, the user may choose to add items to their pantry, view sustainability reports, check financial impacts, or examine carbon footprint trends. The app also provides features such as seamless integration with retailers, recipe suggestions based on pantry contents, and the ability to generate and share shopping lists.

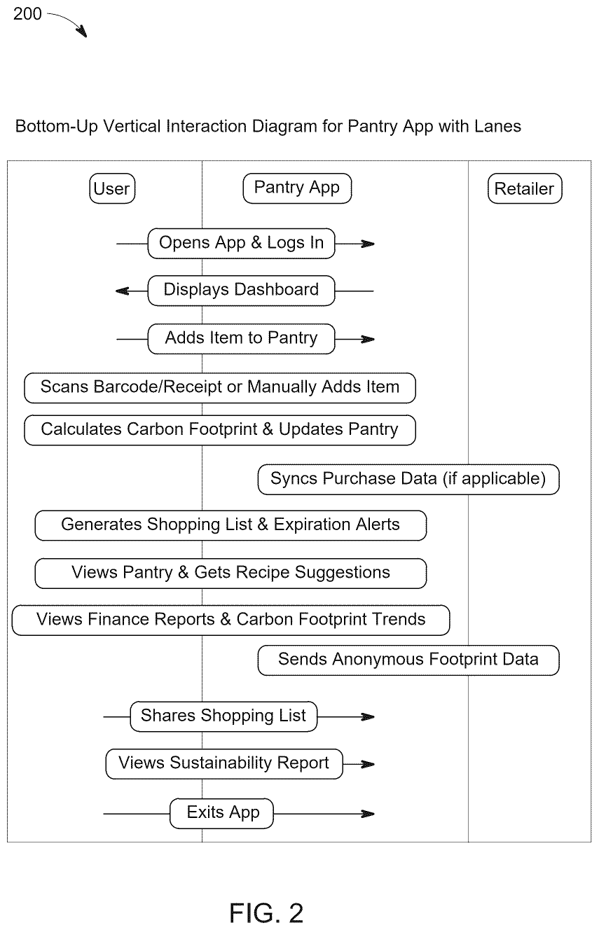

FIG. 2 presents a top down vertical interaction diagram showing the flow of information between the user, the EcoPantryPal application, and retailers and the consumer's carbon foot print data can be sent anonymously to the retailers or third parties that are interested in reducing the carbon foot print. It could be consumed by government body, research centers etc. This diagram illustrates how the app facilitates data exchange and provides various services to the user, such as syncing purchase data with retailers and sending anonymous footprint data for analysis.

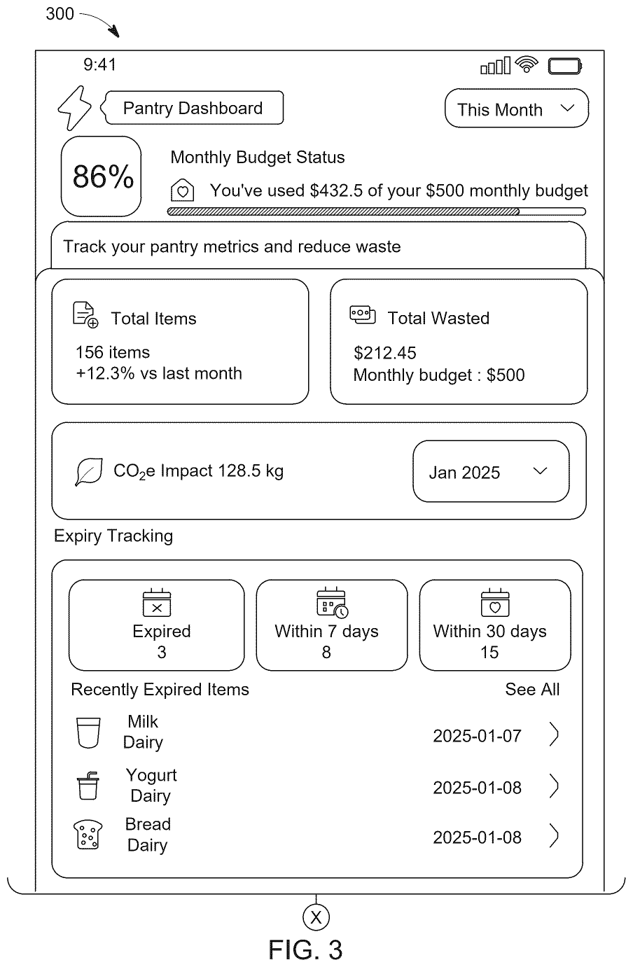

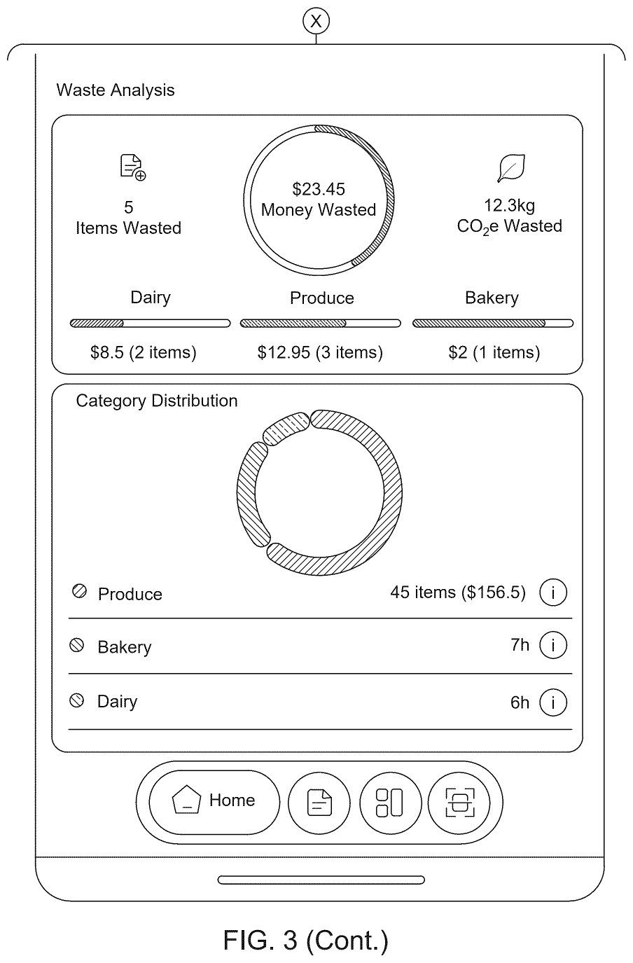

FIG. 3 is a schematic illustration of a mobile dashboard interface displaying current monthly statistics for a pantry management system, in accordance with embodiments of the present disclosure. The dashboard may include a header section showing the current date and navigation options. A “Monthly Budget Status” section may display a circular progress indicator showing the percentage of budget used, such as 86% completion. The dashboard may present key metrics including “Total Items”, which may show a count of items in the inventory and a percentage change from the previous month. A “Total Wasted” metric may display the monetary value of wasted items against the monthly budget. The dashboard may also include a “CO2 Impact” metric showing the carbon footprint for the current month.

An “Expiry Tracking” section may highlight recently expired items, categorized by type with expiration dates. A “Waste Analysis” section may provide a breakdown of wasted items by category, showing both monetary value and CO2 impact. The dashboard may also include a “Category Distribution” section with a pie chart illustrating the distribution of items across different categories such as Produce, Bakery, and Dairy. Navigation icons may be displayed at the bottom of the screen for easy access to different app functions.

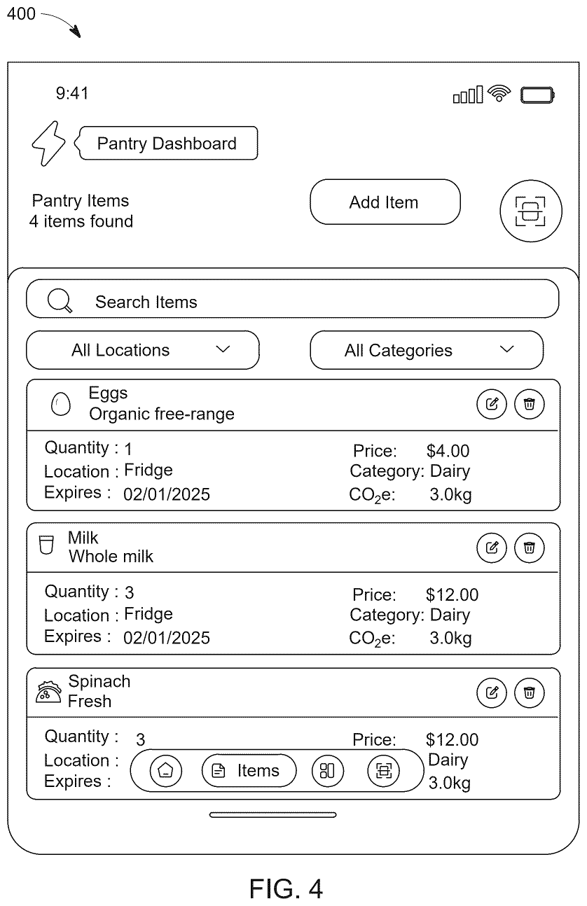

FIG. 4 is a schematic illustration of a smartphone screen displaying a pantry dashboard with item details, in accordance with embodiments of the present disclosure. The interface may include a header labeled “Pantry Dashboard” and a section titled “Pantry Items” showing the number of items found. An “Add Item” button may be provided for adding new items to the inventory. A search bar may be included to allow users to search for specific items.

The dashboard may display a list of pantry items, each with detailed information. For each item, the interface may show the item name, quantity, price, storage location, category, expiration date, and CO2 equivalent (CO2e) impact. For example, an entry for “Eggs” may display details such as “Organic free-range”, quantity, price, location (e.g., Fridge), category (e.g., Dairy), expiration date, and CO2e impact in kilograms. Similar details may be shown for other items such as milk and spinach. A navigation bar with icons may be provided at the bottom of the screen for easy access to different app functions.

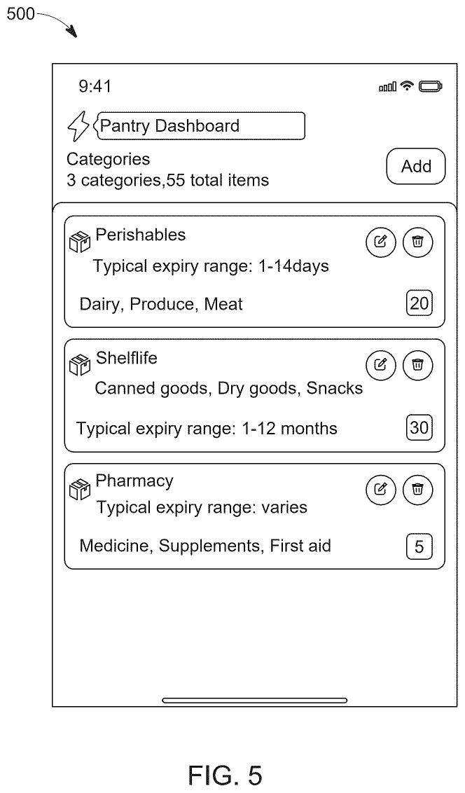

FIG. 5 is a schematic illustration of a mobile device screen showing categories of items in a pantry management system, in accordance with embodiments of the present disclosure. The interface may be labeled as “Pantry Dashboard” and display a “Categories” section.

The main section may show the total number of categories and items, such as “3 categories, 55 total items.” An “Add” button may be provided to add new categories. The interface may list different categories of items, each with a description and examples. For instance, a “Perishables” category may be described with a typical expiry range and examples such as “Dairy, Produce, Meat.” Each category may have a button showing the number of items in that category. Other categories like “Shelf life” and “Pharmacy” may be similarly displayed with their respective descriptions and item counts. A navigation bar at the bottom of the screen may include icons for quick access to different sections of the app, such as home, categories, and notes.

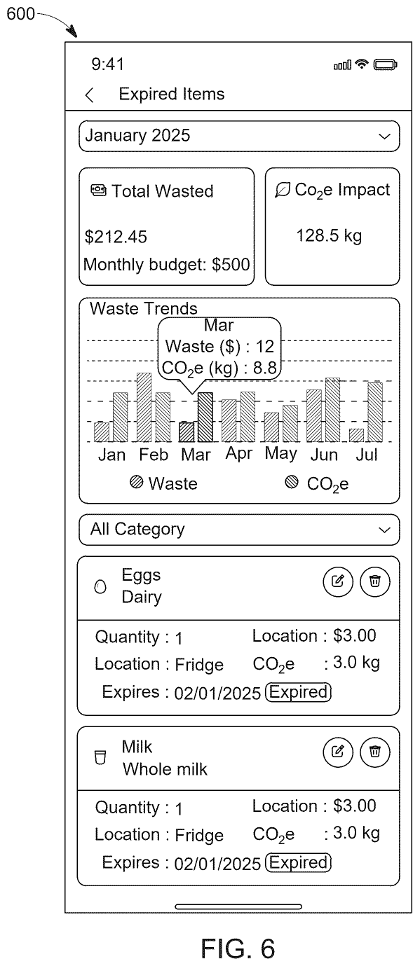

FIG. 6 is a schematic illustration of a mobile app interface displaying data on expired items and associated waste trends, in accordance with embodiments of the present disclosure. The interface may show a summary for a specific month, such as January 2025, including the total monetary value of wasted items and the associated CO2e impact. A “Waste Trends” section may display a graph illustrating waste and CO2e trends over several months, with bars representing monetary waste and CO2e impact for each month.

The interface may also provide detailed information on expired items. For each expired item, the display may include the item name, category, quantity, storage location, CO2e impact, and expiration date. For example, entries for expired eggs and milk may be shown with their respective details. This detailed view may help users track which items are expiring and understand the environmental and financial impact of food waste. The user receives a notification three days prior to the item's expiration date. Additionally, the application recommends recipes to help consume items approaching expiration.

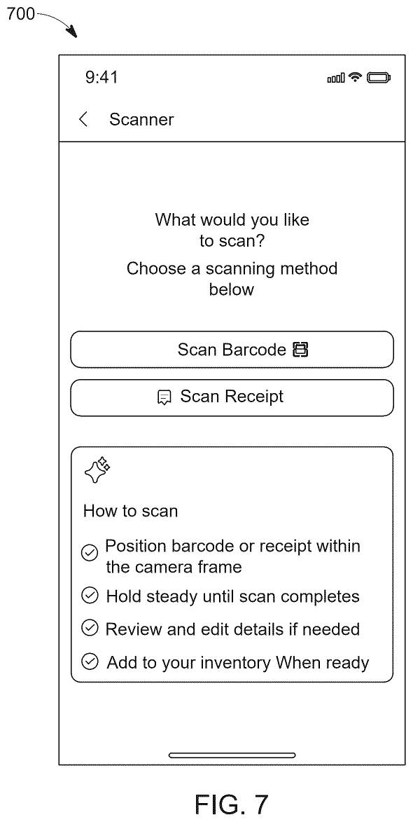

FIG. 7 is a schematic illustration of a smartphone screen showing a scanning interface for adding items to a pantry management system, in accordance with embodiments of the present disclosure. The interface may display the current time and system status icons at the top of the screen. A “Scanner” title may be shown, followed by a prompt asking, “What would you like to scan?” The interface may offer two scanning options: “Scan Barcode” and “Scan Receipt”, each represented by a button.

Below the scanning options, the interface may provide a “How to scan” section with step-by-step instructions for users. These instructions may guide users on how to position the barcode or receipt, hold the device steady, review scanned details, and add items to their inventory. This user-friendly interface may aim to simplify the process of adding new items to the pantry management system.

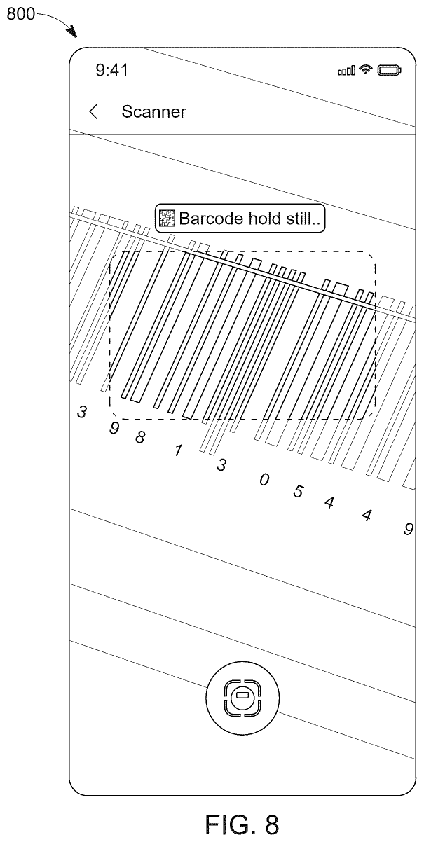

FIG. 8 is a schematic illustration of a smartphone screen displaying a barcode scanner in use, in accordance with embodiments of the present disclosure. The screen may show a live camera view focused on a barcode. The barcode may be clearly visible, with its corresponding numerical code displayed beneath it, such as “3981305449”. A camera icon or button may be positioned at the bottom of the screen, indicating the option to capture the barcode image. This interface may allow users to easily scan product barcodes to add items to their pantry inventory.

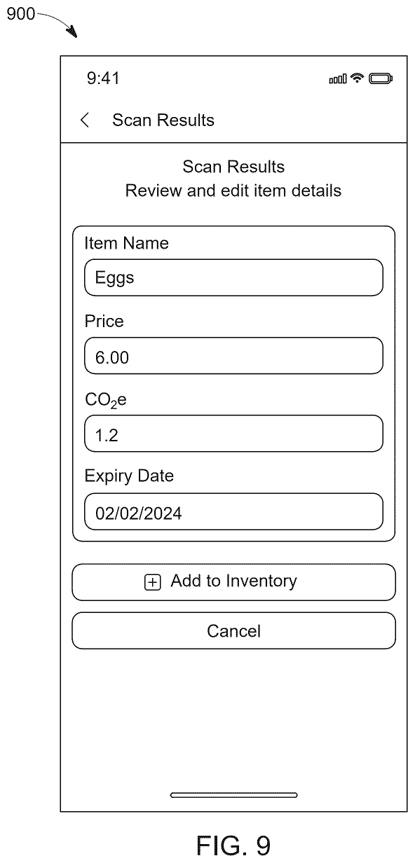

FIG. 9 is a schematic illustration of a mobile app interface showing scan results for an item, in accordance with embodiments of the present disclosure. The interface may be titled “Scan Results” and displays the details of a scanned item. Fields may include “Item Name”, “Price”, “CO2e” (carbon dioxide equivalent), and “Expiry Date”. For example, the scanned item may be “Eggs” with a price of “6.00”, a CO2e value of “1.2”, and an expiry date of “Feb. 2, 2024”. At the bottom of the screen, two buttons may be provided: “Add to Inventory” and “Cancel”, allowing users to either confirm adding the scanned item to their inventory or cancel the operation.

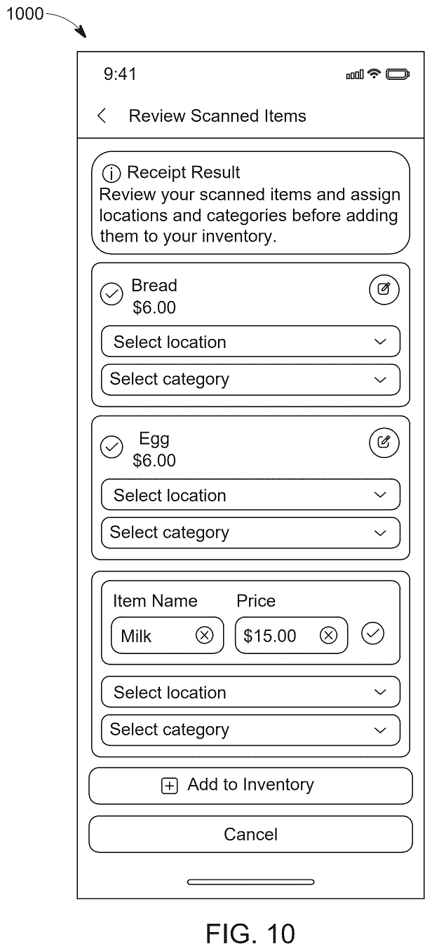

FIG. 10 is a schematic illustration of a mobile app interface for reviewing scanned items from a receipt, in accordance with embodiments of the present disclosure. The interface may be titled “Review Scanned Items” with a subtitle “Receipt Result”. Instructions may prompt users to review scanned items and assign locations and categories before adding them to the inventory. The interface may display a list of scanned items, each with fields for the item name, price, location, and category. For example, items like “Bread”, “Egg”, and “Milk” may be listed with their respective prices. Dropdown menus or input fields may be provided for users to select or enter the storage location and category for each item. At the bottom of the screen, “Add to Inventory” and “Cancel” buttons may allow users to either confirm adding the scanned items or cancel the operation.

The Ecopantrypal system may include several key components:
1. User Interface: The user interface may be implemented as a mobile application or web platform, allowing users to interact with the system, input data, and view reports. FIG. 3 shows an example of a mobile dashboard interface displaying current monthly statistics, including budget status, total items, waste analysis, and expiry tracking.
2. Database: A central database stores information about pantry items, including details such as name, quantity, price, expiration date, storage location, and associated carbon footprint. FIG. 4 illustrates a pantry dashboard displaying item details as stored in the database.
3. Scanning Module: The system includes functionality for scanning barcodes and receipts to facilitate easy data entry. FIG. 7 shows a scanning interface that allows users to choose between scanning a barcode or a receipt. FIG. 8 demonstrates the barcode scanning process, while FIG. 9 displays the results of a successful scan.
4. Analytics Engine: An analytics engine processes the stored data to generate insights, calculate financial impacts, and estimate carbon footprints. FIG. 6 shows an example of how this processed data may be presented to the user, displaying waste trends and CO2e impact.
5. Notification System: The app includes a notification system to alert users about expiring items, suggests recipes to reduce waste, and provide tips for more sustainable consumption.
6. Integration Module: This component facilitates integration with retailer systems for automated data entry and purchase tracking. In one or more instances, the integration module may also integrate with one or more third-party vendors that may provide CO2e for one or more items.

The EcoPantryPal system may operate as follows:
1. Item Entry: Users can add items to their pantry inventory through various methods:
   a. Barcode Scanning: Users can scan product barcodes using their device's camera. The system then retrieves product information from a database or prompts the user to enter details manually if the product is not recognized.
   b. Receipt Scanning: Users can scan shopping receipts, and the system will automatically parse the information to add multiple items at once. FIG. 10 shows an interface for reviewing scanned items from a receipt before adding them to the inventory.
   c. Manual Entry: Users can manually input item details for products without barcodes or when other methods are not available.
   d. Retailer Integration: The system can automatically update the inventory based on purchases made through integrated retailer accounts.
2. Inventory Management: The system organizes items by category and storage location. FIG. 5 illustrates how items may be categorized within the app, including perishables, shelf-stable items, and pharmacy products.
3. Expiration Tracking: The system tracks expiration dates for all items and sends notifications to users when items are approaching their expiration date. For items without clear expiration dates, the system may use machine learning algorithms to suggest appropriate consumption timeframes based on typical shelf lives and storage conditions.
4. Usage Tracking: Users can log when they use or dispose of items, allowing the system to maintain accurate inventory and track consumption patterns.
5. Waste Analysis: The system calculates the financial impact of wasted items based on their purchase price and the quantity wasted. It also estimates the carbon footprint associated with the production and disposal of wasted items.
6. Carbon Footprint Calculation: For each item, the system estimates its carbon footprint based on factors such as production method, transportation, and packaging. This information is aggregated to provide users with an overall carbon footprint for their pantry and consumption habits. In one or more instances, this may be accomplished by integrating with one or more third-party vendors that may provide CO2e data for one or more items.
7. Reporting and Insights: The system generates reports and visualizations to help users understand their consumption patterns, waste levels, financial impacts, and carbon footprint. These insights may include:
   a. Monthly summaries of purchases, consumption, and waste
   b. Trends in carbon footprint over time
   c. Comparisons of actual consumption versus planned or budgeted amounts
   d. Recommendations for reducing waste and improving sustainability
8. Recipe Suggestions: Based on the current inventory and expiration dates, the system suggests recipes to help users consume items before they expire, reducing potential waste.
9. Shopping List Generation: The system can generate shopping lists based on consumption patterns, current inventory levels, and user-defined preferences. These lists may prioritize low-carbon footprint options when available.
10. Health and Dietary Considerations: The system may incorporate users' health profiles, allergies, or dietary restrictions to provide personal recommendations and warnings about unsuitable products.
11. Retailer Collaboration: The system may share anonymized data with partnering retailers to help them optimize their inventory management and promote more sustainable products.

The EcoPantryPal system provides several benefits:
1. Reduced Food Waste: By tracking expiration dates and suggesting timely consumption, the system helps users minimize food waste.
2. Financial Savings: Users can visualize the financial impact of their waste, encouraging more mindful purchasing and consumption habits.
3. Environmental Awareness: The carbon footprint tracking feature raises awareness about the environmental impact of food choices and waste.
4. Improved Inventory Management: Users can easily track what they have on hand, reducing duplicate purchases and ensuring timely use of perishable items.
5. Health and Safety: By tracking expiration dates for medications and cosmetics, the system helps users avoid using potentially harmful expired products.
6. Data-Driven Insights: The analytics provided by the system help users make more informed decisions about their purchasing and consumption habits. In one or more instances, the analytics provided to the retailers can help them better manage their purchasing. The analytics can also be shared with any eco-conscious government body or research center for further analysis.

The anonymous data sent to retailers can provide valuable insights to optimize their inventory management and purchasing decisions. By analyzing aggregated consumer behavior and consumption patterns, retailers can make more informed choices about stock levels, product placement, and promotional strategies. This data-driven approach can lead to reduced waste, improved efficiency, and better alignment with consumer preferences.

Furthermore, the sharing of anonymized data with eco-conscious government bodies and research centers can contribute to broader sustainability initiatives and studies. These organizations can use the data to:
1. Assess the environmental impact of consumer behavior on a larger scale
2. Identify trends in sustainable consumption practices
3. Develop and refine policies aimed at reducing food waste and carbon emissions
4. Conduct research on the effectiveness of various sustainability interventions
5. Inform public education campaigns on sustainable consumption and waste reduction

By facilitating this data sharing, the EcoPantryPal system can play a crucial role in advancing sustainability efforts beyond individual households, contributing to more comprehensive and effective environmental protection strategies at a societal level.
7. Time Savings: Automated data entry through receipt and barcode scanning, along with retailer integration, saves users time in managing their pantry inventory.

In some embodiments, the EcoPantryPal system may be implemented as a cloud-based service, allowing users to access their pantry information from multiple devices. The system may also incorporate machine learning algorithms to improve its predictions and recommendations over time based on user behavior and feedback. Future enhancements to the system may include integration with smart home devices, such as smart refrigerators or pantry cameras or other IoT devices, to further automate inventory tracking. The system could also expand to include features for meal planning, nutritional analysis, and collaborative shopping for households with multiple members.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method for pantry management with carbon footprint tracking, comprising:
receiving, by a computing device, input data related to household items;
storing the input data in a database;
tracking usage and expiration of the household items;
calculating financial and environmental impacts carbon footprint of item usage and waste; and
generating reports and recommendations based on the tracked data.

2. The method of claim 1, wherein receiving input data comprises at least one of:
scanning a barcode of an item;
scanning a receipt containing multiple items;
manually entering item details; and
receiving data from an integrated retailer system.

3. The method of claim 1, wherein tracking usage and expiration comprises:
monitoring expiration dates of items;
sending notifications for items approaching expiration; and
updating inventory based on user-reported usage or disposal.

4. The method of claim 1, wherein calculating financial and environmental impacts comprises:
determining a monetary value of wasted items; and
estimating a carbon footprint associated with production and disposal of wasted items.

5. The method of claim 1, wherein generating reports and recommendations comprises:
providing monthly summaries of purchases, consumption, and waste;
displaying trends in carbon footprint over time;
suggesting recipes based on current inventory and expiration dates; and
generating shopping lists based on consumption patterns and inventory levels.

6. The method of claim 1, further comprising:
categorizing items by storage location and type;
providing a user interface for managing inventory across multiple storage locations; and
tracking non-food items including medications and cosmetics.

7. The method of claim 1, further comprising:
integrating with retailer systems to automatically update inventory based on purchases;
sharing anonymized data with partnering retailers to optimize their inventory management and promote sustainable products; and
incorporating user health profiles and dietary restrictions to provide personalized recommendations.

8. A system for pantry management with carbon footprint tracking, comprising:
a user interface for inputting and displaying item data;
a database for storing item information;
a processor configured to:
receive input data related to household items;
store the input data in the database;
track usage and expiration of the household items;
calculate financial and environmental impacts of item usage and waste;
generate reports and recommendations based on the tracked data; and
a notification module for alerting users to expiring items and providing sustainability recommendations.

9. The system of claim 8, further comprising:
a scanning module for capturing barcode and receipt data; and
an integration module for connecting with retailer systems to automatically update inventory.

10. The system of claim 8, wherein the processor is further configured to:
categorize items by storage location and type;
provide recipe suggestions based on current inventory and expiration dates; and
generate shopping lists based on consumption patterns and inventory levels.

11. The system of claim 8, wherein the processor is further configured to:
estimate carbon footprints for individual items based on production method, transportation, and packaging; and
aggregate carbon footprint data to provide an overall environmental impact assessment.

12. The system of claim 8, wherein the processor is further configured to:
incorporate user health profiles and dietary restrictions to provide personalized recommendations; and
track non-food items including medications and cosmetics.

13. The system of claim 8, wherein the notification module is configured to:
send alerts for items approaching expiration;
provide suggestions for reducing waste; and
offer tips for more sustainable consumption habits.

14. The system of claim 8, wherein the processor is further configured to:
analyze consumption patterns and waste levels over time;
identify trends in user behavior related to sustainability;
provide data-driven insights to help users make more informed decisions about purchasing and consumption habits; and
transmit anonymized data to retailers to assist in inventory management and purchasing decisions.

15. A non-transitory computer-readable medium storing instructions that, when executed by a processor, cause the processor to perform operations comprising:
receiving input data related to household items;
storing the input data in a database;
tracking usage and expiration of the household items;
calculating financial impacts and carbon footprint of item usage and waste;
generating reports and recommendations based on the tracked data; and
transmitting anonymized usage and waste data to partnering retailers to optimize inventory management and promote sustainable products.

16. The non-transitory computer-readable medium of claim 15, wherein the operations further comprise:
providing a user interface for managing inventory across multiple storage locations;
integrating with retailer systems to automatically update inventory based on purchases; and
sharing anonymized data with partnering retailers to optimize inventory management and promote sustainable products.

17. The non-transitory computer-readable medium of claim 15, wherein calculating financial and environmental impacts comprises:
determining a monetary value of wasted items;
estimating a carbon footprint associated with production and disposal of wasted items; and
aggregating carbon footprint data to provide an overall environmental impact assessment.

18. The non-transitory computer-readable medium of claim 15, wherein generating reports and recommendations comprises:
providing monthly summaries of purchases, consumption, and waste;
displaying trends in carbon footprint over time;
suggesting recipes based on current inventory and expiration dates; and
generating shopping lists based on consumption patterns and inventory levels.

19. The non-transitory computer-readable medium of claim 15, wherein the operations further comprise:
incorporating user health profiles and dietary restrictions to provide personalized recommendations;
tracking non-food items including medications and cosmetics; and
sending notifications for items approaching expiration and providing sustainability recommendations.

20. The non-transitory computer-readable medium of claim 15, wherein the operations further comprise:
analyzing consumption patterns and waste levels over time;
identifying trends in user behavior related to sustainability; and
providing data-driven insights to help users make more informed decisions about purchasing and consumption habits.
